(19) United States
(12) Patent Application Publication
(10) Pub. No.: US 2016/0107634 A1
(43) Pub. Date: Apr. 21, 2016

(54) SYSTEM AND METHOD FOR CONTROLLING TORQUE OF HYBRID VEHICLE

(71) Applicants: Hyundai Motor Company, Seoul (KR); Kia Motors Corporation, Seoul (KR)

(72) Inventors: Sang Joon Kim, Seoul (KR); Jee Wook Huh, Bucheon (KR); Teh Hwan Cho, Anseong (KR)

(21) Appl. No.: 14/852,566

(22) Filed: Sep. 13, 2015

(30) Foreign Application Priority Data
Oct. 17, 2014 (KR) 10-2014-0141161

(51) Int. Cl. B60W 20/00; B60W 10/08; B60W 10/06

(52) U.S. Cl. CPC B60W 20/108; B60W 10/06; B60W 10/08; B60W 2510/244; B60W 2710/0666; B60W 2710/083; B60W 2520/26; Y10S 903/93

(57) ABSTRACT

A system for controlling torque controls torque during traction control of a hybrid vehicle which uses a motor and an engine as power sources. The system for controlling torque may include: a traction control system (TCS) that detects wheel slip of a front wheel or a rear wheel when the hybrid vehicle is accelerated and requests an intervention torque; a battery sensor that measures state of charge (SOC) in real time; and a vehicle controller that determines a set value of a limit torque according to the SOC transmitted from the battery sensor when requesting the intervention torque and decreases a motor torque according to the set value of the limit torque when the SOC is lower than a predetermined threshold, and then increases an engine torque by as much as the motor torque is decreased.

### CROSS-REFERENCE TO RELATED APPLICATION

This application claims under 35 U.S.C. §119(a) the benefit of Korean Patent Application No. 10-2014-0141161 filed in the Korean Intellectual Property Office on Oct. 17, 2014, the entire contents of which are incorporated herein by reference.

### BACKGROUND

(a) Field of the Invention

The present invention relates to a system and a method for controlling torque of a hybrid vehicle, more particularly, to a system and a method for controlling torque which controls torque by considering a charge condition of a battery when a traction control system (TCS) is operated.

(b) Description of the Related Art

A hybrid vehicle is a vehicle which uses at least two different kinds of power sources. Generally, the vehicle is driven by an engine which gains driving torque by combusting fuel, and a motor which gains driving torque by battery power.

In the hybrid vehicle, a hybrid controller (Hybrid Control Unit, or “HCU”) generally controls the hybrid vehicle, an engine controller (Engine Control Unit, or “ECU”) generally controls engine operation, a motor controller (Motor Control Unit, or “MCU”) generally controls a drive motor, a transmission controller (Transmission Control Unit, or “TCU”) controls a transmission, and a Battery Management System (“BMS”) monitors and manages a battery condition.

Meanwhile, a Traction Control System (“TCS”) provided in the hybrid vehicle is a safety system which automatically controls the brakes and the engine when starting or accelerating on a snowy road, an icy road, or an asymmetric road so as to prevent each wheel from spinning due to lack of traction and to improve handling stability. The TCS demands torque reduction when a tire spins on the road according to excessive driving torque when the hybrid vehicle starts or accelerates on a slippery road.

In an ordinary hybrid vehicle, torque intervention control is performed by only using a motor so as to ensure rapid control responsiveness when a request torque is generated as the TCS is operated.

For instance, in a conventional TCS control method in the ordinary hybrid vehicle, when a request torque (T_tcs) is generated when the TCS is operated, engine torque (T_eng) is maintained and motor torque (T_m) is changed to satisfy the request torque which is the engine torque (T_eng) subtracted from the request torque (T_tcs).

In particular, according to the conventional method, a demand torque (T_dmd) before the TCS is operated is smaller than the request torque (T_tcs) when the TCS is operated, and the traction control is performed by only reducing the motor torque (T_m).

However, according to the conventional method, it may not be easy for the TCS request torque to be satisfied in case the battery charge is insufficient, and it is impossible for a motor to output torque in a negative direction when the TCS request torque (T_tcs) is very small, a temperature of the battery is high, or the battery is fully charged.

Particularly, over-discharge of the battery may occur as the state of charge (“SOC”) balancing of the battery is insufficient when driving is maintained in the state that the motor outputs a positive torque.

The above information disclosed in this Background section is only for enhancement of understanding of the background of the invention and therefore it may contain information that does not form the prior art that is already known in this country to a person of ordinary skill in the art.

### SUMMARY The present invention provides a system and a method for controlling torque of a hybrid vehicle having advantages of performing torque control by considering a state of charge of a battery.

A system for controlling torque of a hybrid vehicle according to an exemplary embodiment of the present invention may control torque during traction control of the hybrid vehicle, which uses a motor and an engine as power sources. The system for controlling torque of a hybrid vehicle may include: a traction control system (TCS) that detects wheel slip of a front wheel or a rear wheel when the hybrid vehicle is accelerated and requests an intervention torque; a battery sensor that measures state of charge (SOC) in real time; and a vehicle controller that determines a set value of a limit torque according to the SOC transmitted from the battery sensor when requesting the intervention torque and decreases a motor torque according to the set value of the limit torque when the SOC is lower than a predetermined threshold, and then increases an engine torque by as much as the motor torque is decreased.

The set value of the limit torque may be determined from a table which is predetermined such that the motor torque is decreased as the SOC is decreased.

The vehicle controller may control the motor torque and/or the engine torque according to the set value of the limit torque considering the SOC when a torque of the TCS is lower than a torque required by a driver.

The vehicle controller may set an engine command to zero in a normal area in which the SOC is equal to or greater than the predetermined threshold when requesting the intervention torque, and then may control the torque of the TCS by a motor command.

The normal area may be an area in which power derating of the battery is not performed.

The vehicle controller may calculate a motor command based on the set value of the limit torque, and may calculate an engine command by subtracting the motor command from a torque of the TCS if the SOC is lower than the predetermined threshold.

A method for controlling torque of a hybrid vehicle according to an exemplary embodiment of the present invention may control torque during traction control of the hybrid vehicle, which uses a motor and an engine as power sources. The method for controlling torque of the hybrid vehicle may include: a) determining whether a torque of a traction control system (TCS) is generated; b) comparing the torque of the TCS with a torque required by a driver when there is the TCS request torque; c) obtaining a state of charge (SOC) from a battery sensor if the TCS request torque is lower than the torque required by a driver; and d) decreasing a motor torque according to a set value of a limit torque about the SOC when the SOC is lower than a predetermined threshold and then increasing an engine torque by as much as the motor torque is decreased.

The c) step may include controlling a present engine command to be the same as a past engine command and a present motor command to be the same as a past motor command if the TCS request torque is equal to or greater than the torque required by a driver.

The d) step may include controlling an engine command to be zero and the TCS request torque by only the motor command if the SOC is equal to or greater than a predetermined threshold.

The d) step may include calculating a motor command through which the motor torque is decreased based on the set value of the limit torque and calculating an engine command by subtracting the motor command from the TCS request torque.

### BRIEF DESCRIPTION OF THE DRAWINGS

FIG. 1 is a schematic diagram of a hybrid system applying a system for controlling torque of a hybrid vehicle according to an exemplary embodiment of the present invention thereto.

FIG. 2 is a block diagram of a system for controlling torque of a hybrid vehicle according to an exemplary embodiment of the present invention.

FIG. 3 is a graph illustrating a maximum available motor torque limited to respect with a battery SOC according to an exemplary embodiment of the present invention.

FIG. 4 is a graph for showing a control strategy considering a battery SOC according to an exemplary embodiment of the present invention.

FIG. 5 is a flowchart of a method for controlling torque of a hybrid vehicle according to an exemplary embodiment of the present invention.

FIG. 6 and FIG. 7 show test data differences between before and after applying a type of torque control considering a battery SOC according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

The terminology used herein is for the purpose of describing particular embodiments only and is not intended to be limiting of the invention. As used herein, the singular forms “a,” “an” and ^{the} are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

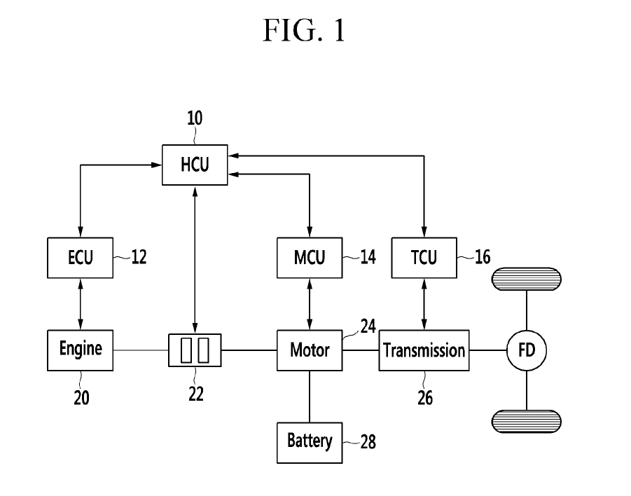

FIG. 1 is a schematic diagram of a hybrid system applying a system for controlling torque of a hybrid vehicle according to an exemplary embodiment of the present invention thereto.

For ease of comprehension and convenience of description, a hybrid system in FIG. 1 incorporates an exemplary embodiment of the present invention. Therefore, a system for controlling torque of a hybrid vehicle according to an exemplary embodiment of the present invention may be applied to not only a hybrid system of FIG. 1, but also to all other hybrid systems.

Referring to FIG. 1, a hybrid system applied to the present invention includes an HCU 10, an ECU 12, an MCU 14, a TCU 16, an engine 20, an engine clutch 22, a motor 24, a transmission 26, and a battery 28.

The HCU 10 is a top level controller which controls operation of the other controllers, determines a hybrid driving mode, and performs overall control of a hybrid vehicle. In addition, the HCU 10 is connected with each controller through a high speed CAN communication line so as to supply and receive information therebetween, and is configured to execute cooperation control for controlling output torques of the engine 20 and the motor 24.

The ECU 12 controls an overall operation of the engine 20 according to a signal of torque required by a driver, a coolant temperature, and information of the engine such as an engine torque.

The MCU 14 controls an overall operation of the motor 24 according to a signal of torque required by a driver, a driving mode of a hybrid vehicle, and SOC of the battery 28.

The TCU 16 controls an overall operation of the transmission 26 such as controlling speed ratios of the transmission 26 according to each output torque of the ECU 12 and the MCU 14 and determining the amount of regenerative braking.

The above-mentioned hybrid system is well-known to a person of ordinary skill in the art, so a detailed description thereof will be omitted.

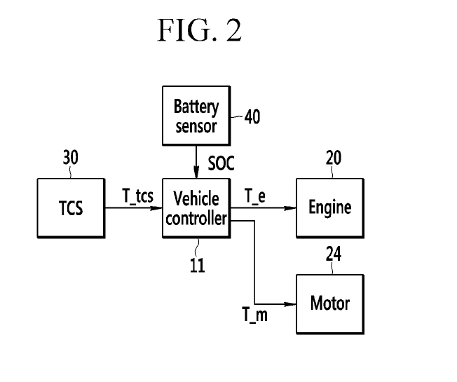

FIG. 2 is a block diagram of a system for controlling torque of a hybrid vehicle according to an exemplary embodiment of the present invention.

Referring to FIG. 2, a system for controlling torque of a hybrid vehicle according to an exemplary embodiment of the present invention includes a TCS (Traction Control System) 30, a battery sensor 40, a vehicle controller 11, an engine 20, and a motor 24.

The hybrid vehicle according to an exemplary embodiment of the present invention includes at least one engine 20 and at least one motor 24. In addition, the engine 20 and the motor 24 respectively include an engine controller and a motor controller for controlling each one so as to provide a driving mode such that they are operated as power sources either individually or simultaneously.

A partial process of a method for controlling torque of a hybrid vehicle according to an exemplary embodiment of the present invention may be performed by the ECU 12, and the other partial process may be performed by the HCU 10. According to an exemplary embodiment of the present invention, the ECU 12 and the HCU 10 can be described as one vehicle controller 11, such that the ECU 12 and the HCU 10 will be referred to as a “vehicle controller 11” hereinafter.

The TCS 30 is a driving torque control apparatus which generates a TCS request torque (T_tcs) for decreasing torque if wheel slip of a front wheel or a rear wheel is detected when a vehicle is accelerated.

In further detail, the TCS 30 is a safety system which controls a driving torque so as to prevent a tire from slipping by an excessive driving torque when starting or accelerating on a snowy road, an icy road, or an asymmetric road. Therefore, the TCS 30 detects a tire slip by an excessive driving torque when the hybrid vehicle starts or accelerates on a slippery road and appropriately requests an intervention torque.

The battery sensor 40 measures a charge condition of the battery 28 (State of Charge, SOC) in real time and transmits the charge condition to the vehicle controller 11.

The battery sensor 40 may include a battery controller such as an IBS (Intelligent Battery Sensor). In addition, the battery sensor 40 precisely measures battery voltage, battery current, and a temperature near the battery, and measures SOC based on the battery voltage, the battery current, and the temperature near the battery so as to transmit the SOC to the vehicle controller 11.

The vehicle controller 11 calculates a driver demand torque (T_dmd) by considering a value determined by movement of an accelerator pedal when accelerating when the intervention torque is requested from the TCS 30, and distributes it to an engine torque (Tm_before) and a motor torque (Te_before) based on the driver demand torque (T_dmd).

The vehicle controller 11 controls a present engine command (T_e) to be the same as a past engine command (Te_before) and controls a present motor command (T_m) to be the same as a past motor command (Tm_before) when the TCS request torque (T_tcs) is the same as or higher than the driver demand torque (T_dmd) (in case T_tcs>=T_dmd, T_e=Te_before and T_m=Tm_before). Herein, the engine command and the motor command, which are commands for respectively controlling torques of the engine and the motor, indwell mean of an engine torque value and a motor torque value.

The vehicle controller 11 does not decrease torque by depending on the motor but controls torque by considering the battery SOC when the TCS request torque (T_tcs) is lower than the driver demand torque (T_dmd).

The SOC is a measure representing energy remaining in the battery 28. The SOC is continually decreased by electrical discharges by the motor when the hybrid vehicle consistently uses electrical power, and it is required that electrical power is limited for protecting the battery 28 if the SOC is lower than a predetermined threshold.

According to an exemplary embodiment of the present invention, the vehicle controller 11 determines the set value of the limit torque according to the SOC gained from the battery sensor 40.

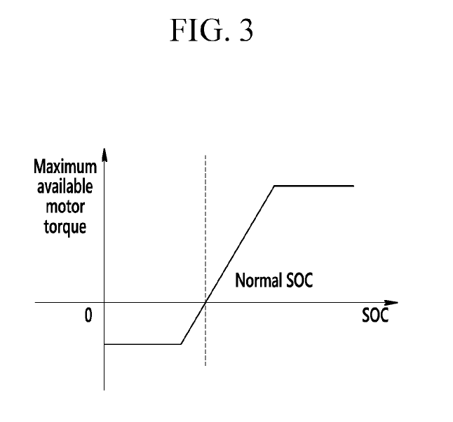

FIG. 3 is a graph illustrates maximum available motor torque limit with respect to a battery SOC according to an exemplary embodiment of the present invention.

Referring to FIG. 3, the set value of the limit torque forms a table such that the motor torque is decreased as the SOC is decreased (i.e., a negative value in the lower area).

Herein, a normal SOC area of the battery may be different and relative with respect to specifications of the battery. Herein, the normal SOC area of the battery may be regarded as an area in which power derating of the battery is not performed.

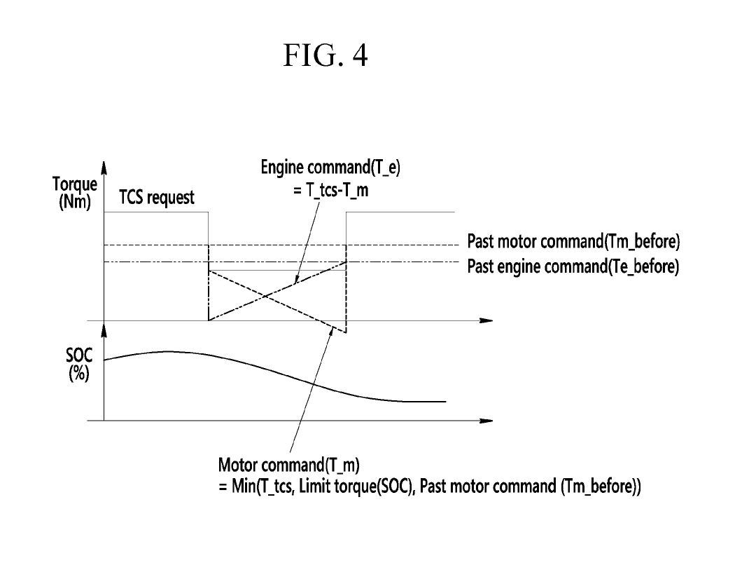

FIG. 4 is a graph for showing a control strategy considering a battery SOC according to an exemplary embodiment of the present invention.

Referring to FIG. 4, the vehicle controller 11 sets the engine command (T_e) to zero and controls the TCS request torque (T_tcs) by a motor command (T_m) in the normal SOC area in which the SOC is equal to or greater than the predetermined threshold when the intervention torque is required from the TCS 30.

The vehicle controller 11 controls to decrease the motor torque and increase the engine torque by as much as the decreased motor torque when the SOC of the battery is lower than the predetermined threshold.

Considering the two cases, the below equation can be represented.

T_m=min(T_tcs, Tm_before, set value of the limit torque according to SOC) (Equation 1)

T_e=T_tcs−T_m

Herein, T_m means the motor command, T_tcs means the TCS request torque, Tm_before means the past motor command, and T_e means the engine command.

Referring to Equation 1, the vehicle controller 11 calculates the motor command (T_m) based on the set value of the limit torque according to the SOC and calculates the engine command (T_e) by subtracting the motor command (T_m) from the TCS request torque (T_tcs) if the SOC of the battery is lower than the predetermined threshold.

Therefore, the overdischarge of the battery can be prevented and follow-up control of torque may be possible as the vehicle controller 11 decreases the motor torque according to the set value of the limit torque and increases engine torque by as much as the motor torque is decreased in the state that the battery SOC is low.

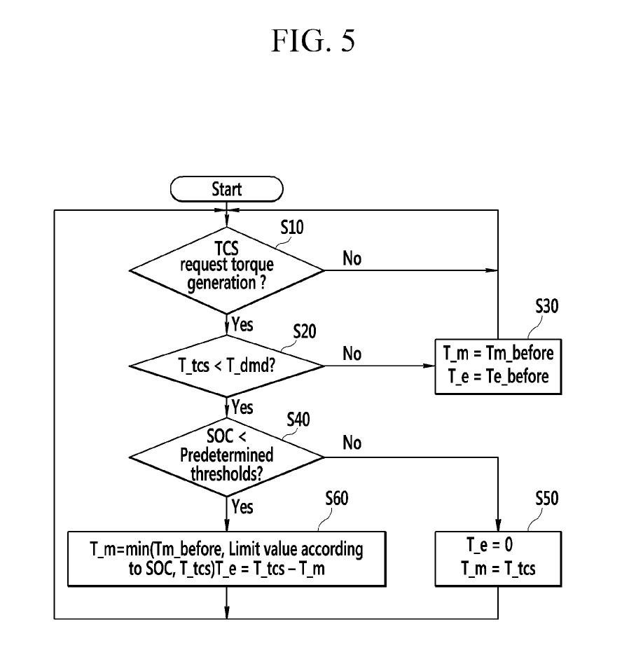

Hereinafter, referring to FIG. 5, a method for controlling torque of a hybrid vehicle based on the system for controlling torque of a hybrid vehicle according to an exemplary embodiment of the present invention will be described.

FIG. 5 is a flowchart of a method for controlling torque of a hybrid vehicle according to an exemplary embodiment of the present invention.

Referring to FIG. 5, a method for controlling torque of a hybrid vehicle according to an exemplary embodiment of the present invention is started by the vehicle controller 11 determining whether a request torque is generated from the TCS 30 at step S10.

The vehicle controller 11 compares the TCS request torque with the driver demand torque at step S20 when the TCS request torque is generated in step S10 (S 10; YES).

At this time, the vehicle controller 11 calculates the driver demand torque by considering a position to which an accelerator pedal is moved by a driver when accelerating, and controls the present engine command (T_e) to be the same as the past engine command (Te_before) and the present motor command (T_m) to be the same as the past motor command (Tm_before) at step S30 if the TCS request torque is the same as or higher than the driver demand torque (S20; NO).

The vehicle controller 11 performs the torque control considering the battery SOC if the TCS request torque is lower than the driver demand torque (T_tcs<T_dmd) in step S20 (S20; YES).

The vehicle controller 11 sets the engine command (T_e) to zero and controls the TCS request torque (T_tcs) by only the motor command (T_m) at step S50 in the normal SOC area in which the SOC is equal to or greater than the predetermined threshold (S40; NO).

The vehicle controller 11 calculates the motor command (T_m) based on the set value of the limit torque according to the low SOC of the battery and calculates the engine command (T_e) by subtracting the motor command (T_m) from the TCS request torque (T_tcs) at step S60 if the SOC of the battery is lower than the predetermined threshold in step S40.

In particular, the vehicle controller 11 performs the torque control so as to decrease the motor torque and increase the engine torque by as much as the decreased motor torque in the state that the battery SOC is lower than the predetermined threshold such that the overdischarge of the battery is prevented.

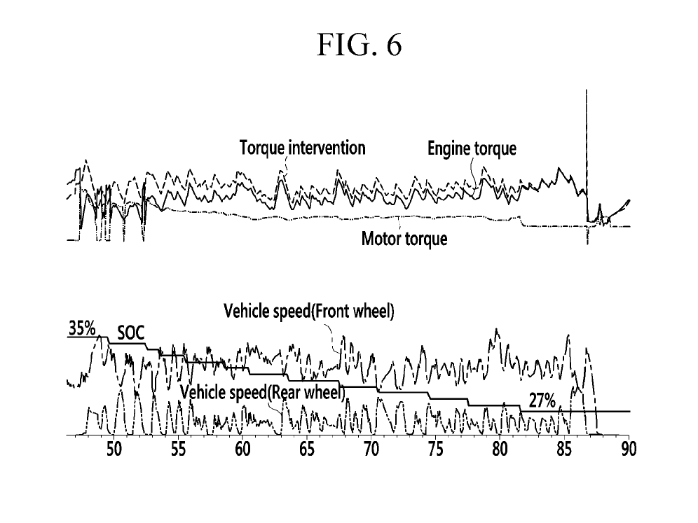

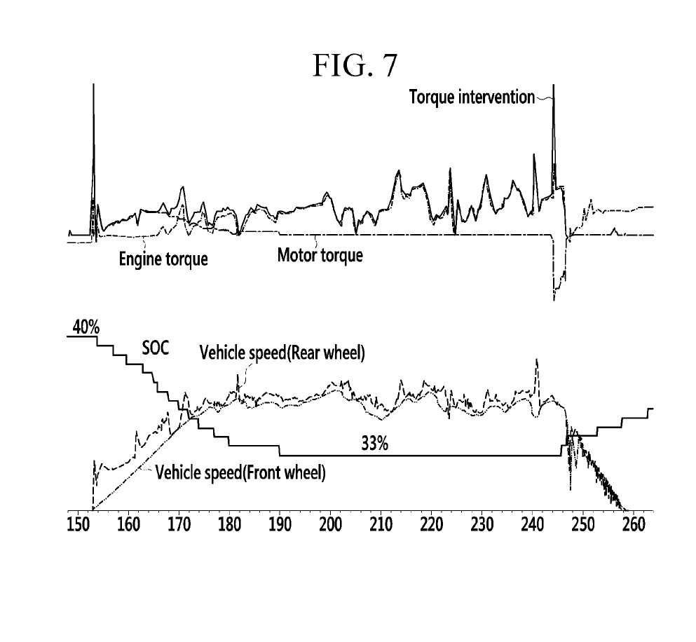

FIG. 6 and FIG. 7 show test data differences between before and after applying a type of torque control considering a battery SOC according to an exemplary embodiment of the present invention.

FIG. 6, which represents experimental data before improvement, shows the over-discharge, that the battery SOC becomes a minimum of 27%, and is generated by consistent motor discharge in the ordinary TCS operation. This shows that the battery SOC is consistently discharged by actively using the motor torque for estimating a brake torque.

FIG. 7, which represents experimental data after improvement, shows a result that the SOC is improved from the minimum of 27% to 33% in comparison with before improvement in FIG. 6 as mapping and identification control are performed by minimally using the motor such that the battery SOC can be maintained when the TCS is operated.

According to an exemplary embodiment of the present invention, the SOC balancing may be possible during the TCS control not as an ordinary type of decreasing torque of the motor but by controlling torque by considering the battery SOC.

In addition, the over-discharge of the battery can be prevented and simultaneously the satisfactory follow-up control of torque can be performed as the motor torque is decreased and the engine torque is increased by as much as the decreased motor torque according to the set value of the limit torque when the battery SOC is low when controlling the TCS of the hybrid vehicle.

The above-described exemplary embodiment of the present invention may be realized by an apparatus and a method, but it may also be realized by a program that realizes functions corresponding to configurations of the exemplary embodiment or a recording medium that records the program. Such realization can be easily performed by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A system for controlling torque during traction control of a hybrid vehicle which uses a motor and an engine as power sources, the system comprising:
a traction control system (TCS) that detects wheel slip of a front wheel or a rear wheel when the hybrid vehicle is accelerated and requests an intervention torque;
a battery sensor that measures battery state of charge (SOC) in real time; and
a vehicle controller that determines a set value of a limit torque according to the SOC transmitted from the battery sensor when requesting the intervention torque and which decreases a motor torque according to the set value of the limit torque when the SOC is lower than a predetermined threshold and then increases an engine torque by as much as the motor torque is decreased.

2. The system of claim 1, wherein the set value of the limit torque is provided in a predetermined table such that the motor torque is decreased as the SOC is decreased.

3. The system of claim 1, wherein the vehicle controller controls the motor torque and the engine torque according to the set value of the limit torque based on the SOC when a torque of the TCS is lower than a torque required by a driver.

4. The system of claim 1, wherein the vehicle controller sets an engine command to zero in a normal area in which the SOC is equal to or greater than the predetermined threshold when requesting the intervention torque, and then controls the torque of the TCS by a motor command.

5. The system of claim 4, wherein the normal area is an area in which power derating of the battery is not performed.

6. The system of claim 1, wherein the vehicle controller calculates a motor command based on the set value of the limit torque, and calculates an engine command by subtracting the motor command from a torque of the TCS if the SOC is lower than the predetermined threshold.

7. A method for controlling torque during traction control of a hybrid vehicle which uses a motor and an engine as power sources, the method comprising the steps of:
a) determining whether a torque of a traction control system (TCS) is generated;
b) comparing the torque of the TCS with a torque required by a driver when there is the torque of the TCS;
c) obtaining a state of charge (SOC) from a battery sensor if the torque of the TCS is lower than the torque required by the driver; and
d) decreasing a motor torque according to a set value of a limit torque about the SOC when the SOC is lower than a predetermined threshold and then increasing an engine torque by as much as the motor torque is decreased.

8. The method of claim 7, wherein the c) step further comprises controlling a present engine command to be the same as a past engine command and a present motor command to be the same as a past motor command if the torque of the TCS is equal to or greater than the torque required by the driver.

9. The method of claim 7, wherein the d) step further comprises controlling an engine command to be zero and the torque of the TCS by only the motor command if the SOC is equal to or greater than the predetermined threshold.

10. The method of claim 7, wherein the d) step further comprises calculating a motor command through which the motor torque is decreased based on the set value of the limit torque and calculating an engine command by subtracting the motor command from the torque of the TCS.
